(19) United States
(12) Patent Application Publication
(10) Pub. No.: US 2008/0257312 A1
(43) Pub. Date: Oct. 23, 2008

(54) Control Apparatus for Internal Combustion Engine and Motor Vehicle Equipped With the Same

(76) Inventors: Keiko Hasegawa, Aichi-ken (JP); Kenji Harima, Aichi-ken (JP)

Correspondence Address: KENYON & KENYON LLP, 1500 K STREET N.W., SUITE 700, WASHINGTON, DC, 20005, US

(21) Appl. No.: 10/586,585

(22) PCT Filed: Jan. 21, 2005
(86) PCT No.: PCT/JP2005/001161

§ 371 Date: Jul. 19, 2006

(30) Foreign Application Priority Data
Jan. 23, 2004 (JP) 2004-015461

(51) Int. Cl. F02D 41/30

(52) U.S. Cl. 123/491; 701/103

(57) ABSTRACT

The engine stop control of the invention uses a correction factor k based on an ambient temperature Tdp in the vicinity of a delivery pipe to set an engine-stop criterion fuel pressure Pref as a fuel pressure of ensuring the sufficient startability of an engine and preventing the vapor generation. The engine stop control stops the operation of the engine after a decrease in fuel pressure Pf in the delivery pipe below the engine-stop criterion fuel pressure Pref. This arrangement effectively prevents the fuel oil-tight leaked from fuel injection valves from being accumulated in cylinders of the engine and thus restrains the poor emission, which may be caused by direct discharge of the fuel accumulated in the cylinders at a restart of the engine. The engine stop control of the invention also reduces the frequency of operation of a relief valve, which works to prevent an excessive increase in fuel pressure Pf in the delivery pipe, thus enhancing the durability of the relief valve.

This is a 371 national phase application of PCT/JP2005/001161 filed 21 Jan. 2005 claiming priority to Japanese Applications No. 2004-015461 filed 23 Jan. 2004, the contents of which are incorporated herein by reference.

### FIELD OF THE INVENTION

The present invention relates to a control apparatus for an internal combustion engine, a motor vehicle equipped with such a control apparatus, and a control method of the internal combustion engine. More specifically the invention pertains to a control apparatus for an in-cylinder injection internal combustion engine, a motor vehicle equipped with such a control apparatus, and a control method of the in-cylinder injection internal combustion engine.

### BACKGROUND OF THE INVENTION

One proposed control apparatus for an in-cylinder injection internal combustion engine increases the fuel pressure prior to an auto stop of the internal combustion engine (see, for example, Japanese Patent Laid-Open Gazette No. 2001-317389). The increase fuel pressure prior to an auto stop of the internal combustion engine keeps the fuel pressure at a sufficiently high level for a long time period. Such control aims to allow fuel injection in an early compression stroke and improve the startability of the internal combustion engine for a smooth restart.

### SUMMARY OF THE INVENTION

This proposed control apparatus improves the startability of the internal combustion engine for a smooth restart but does not take into account the emission at the restart of the internal combustion engine. The stop of the internal combustion engine under the increased fuel pressure may cause accumulation of oil-tight-leaked fuel vapor in cylinders with elapse of time. In such cases, the fuel vapor accumulated in the cylinders is directly discharged at a restart of the internal combustion engine to give the poor emission containing uncombusted hydrocarbons (HC). When the internal combustion engine stops at a high temperature or at the high ambient temperature of the ambient air in the vicinity of a fuel pipe, the stop of the internal combustion engine under the increased fuel pressure may cause a further increase in fuel pressure due to thermal expansion of the fuel inside the fuel pipe. A relief valve disposed in the fuel pipe is accordingly operated to prevent an excessive increase of the fuel pressure. Frequent auto stops of the internal combustion engine lead to frequent operations of the relief valve. The relief valve set in the fuel pipe is thus required to have extremely high durability to be durable against such frequent operations.

The control apparatus for an in-cylinder injection internal combustion engine of the invention, the motor vehicle equipped with the control apparatus, and the corresponding control method of the in-cylinder injection internal combustion engine thus aim to improve the emission at a restart of the internal combustion engine. The control apparatus for the in-cylinder injection internal combustion engine of the invention, the motor vehicle equipped with the control apparatus, and the corresponding control method of the in-cylinder injection internal combustion engine also aim to enhance the durability of a relief valve, which is provided in a pressurized fuel supply unit that pressurizes a fuel flow and supplies the pressurized fuel flow to the fuel injection valve.

In order to attain at least part of the above and the other related objects, the control apparatus for an in-cylinder injection internal combustion engine of the invention, the motor vehicle equipped with the control apparatus, and the control method of the in-cylinder injection internal combustion engine have the configurations discussed below.

The control apparatus for the internal combustion engine of the invention is directed to the control apparatus for an in-cylinder injection internal combustion engine. Upon satisfaction of a preset engine stop condition during operation of the internal combustion engine, the control apparatus of the invention executes an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine.

Upon satisfaction of the preset engine stop condition during operation of the in-cylinder injection internal combustion engine, the control apparatus of the invention stops the operation of the internal combustion engine in the state of the lowered valve-side fuel pressure on the fuel injection valve-side in the pressurized fuel supply unit than the fuel pressure level under the normal operation of the internal combustion engine. Here the pressurized fuel supply unit pressurizes the fuel flow and supplies the pressurized fuel flow to the fuel injection valve of the internal combustion engine. This arrangement effectively prevents the fuel oil-tight leaked from the fuel injection valve from being accumulated in a cylinder of the internal combustion engine during the stop of the internal combustion engine. This restrains the poor emission, which may be caused by direct discharge of the fuel accumulated in the cylinder at a restart of the internal combustion engine, and improves the emission. The control apparatus of the invention does not stop the operation of the engine until a decrease of the valve-side fuel pressure. This arrangement desirably reduces the frequency of operation of a relief valve or equivalent mechanism that works to prevent an excessive increase in valve-side fuel pressure, thus enhancing the durability of the relief valve or equivalent mechanism.

Upon satisfaction of a preset engine restart condition, the control apparatus of the invention may execute an engine restart control to restart the operation of the internal combustion engine, which has been stopped by the engine stop control. The internal combustion engine thus automatically starts under the preset engine restart condition.

In one preferable application of the control apparatus of the invention, the engine stop control starts injection of a fuel from the fuel injection valve and fires the injected fuel in the internal combustion engine to lower the valve-side fuel pressure. This application readily lowers the valve-side fuel pressure.

In another preferable application of the control apparatus of the invention, the engine stop control stops the operation of the internal combustion engine only after lowering the valve-side fuel pressure. This application ensures a stop of the operation of the internal combustion engine in the state of the lowered valve-side fuel pressure.

In still another preferable application of the control apparatus of the invention, the engine stop control stops the operation of the internal combustion engine only after lowering the valve-side fuel pressure to or below a preset reference fuel pressure, which is set to ensure startability for a restart of the internal combustion engine under the engine restart control. This application ensures the sufficient startability of the internal combustion engine for a smooth restart.

In one preferable embodiment of the invention, the control apparatus has a temperature detection-estimation unit that either detects or estimates a temperature of the internal combustion engine or an ambient temperature of the ambient air in proximity to the internal combustion engine. In this embodiment, the engine stop control stops the operation of the internal combustion engine in the state of the lowered valve-side fuel pressure, which decreases to a lower level with an increase in temperature detected or estimated by the temperature detection-estimation unit. This arrangement more effectively reduces the frequency of operation of a relief valve or equivalent mechanism that works to prevent an excessive increase in valve-side fuel pressure, thus enhancing the durability of the relief valve or equivalent mechanism.

The present invention is directed to a motor vehicle including: an in-cylinder injection internal combustion engine that outputs a power for driving the motor vehicle; and an engine control apparatus that, upon satisfaction of a preset engine stop condition during operation of the internal combustion engine, executes an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine.

Upon satisfaction of the preset engine stop condition during operation of the in-cylinder injection internal combustion engine, the motor vehicle of the invention stops the operation of the internal combustion engine in the state of the lowered valve-side fuel pressure on the fuel injection valve-side in the pressurized fuel supply unit than the fuel pressure level under the normal operation of the internal combustion engine. Here the pressurized fuel supply unit pressurizes the fuel flow and supplies the pressurized fuel flow to the fuel injection valve of the internal combustion engine. This arrangement effectively prevents the fuel oil-tight leaked from the fuel injection valve from being accumulated in a cylinder of the internal combustion engine during the stop of the internal combustion engine. This restrains the poor emission, which may be caused by direct discharge of the fuel accumulated in the cylinder at a restart of the internal combustion engine, and improves the emission. The control apparatus of the invention does not stop the operation of the engine until a decrease of the valve-side fuel pressure. This arrangement desirably reduces the frequency of operation of a relief valve or equivalent mechanism that works to prevent an excessive increase in valve-side fuel pressure, thus enhancing the durability of the relief valve or equivalent mechanism.

In one preferable embodiment, the motor vehicle of the invention further includes a motor that outputs a power for driving. In this case, the motor vehicle of the invention further enables to run with a changeover of a drive mode between an engine drive mode using the output power of the internal combustion engine and a motor drive mode using only the output power of the motor.

Upon satisfaction of a preset engine restart condition, the engine control apparatus of the motor vehicle may execute an engine restart control to restart the operation of the internal combustion engine, which has been stopped by the engine stop control. The internal combustion engine thus automatically starts under the preset engine restart condition.

In one preferable application of the motor vehicle of the invention, the engine stop control starts injection of a fuel from the fuel injection valve and fires the injected fuel in the internal combustion engine to lower the valve-side fuel pressure. This application readily lowers the valve-side fuel pressure.

In another preferable application of the motor vehicle of the invention, the engine stop control stops the operation of the internal combustion engine only after lowering the valve-side fuel pressure. This application ensures a stop of the operation of the internal combustion engine in the state of the lowered valve-side fuel pressure.

In still another preferable application of the motor vehicle of the invention, the engine stop control stops the operation of the internal combustion engine only after lowering the valve-side fuel pressure to or below a preset reference fuel pressure, which is set to ensure startability for a restart of the internal combustion engine under the engine restart control. This application ensures the sufficient startability of the internal combustion engine for a smooth restart.

In addition, in one preferable embodiment, the motor vehicle of the invention has a temperature detection-estimation unit that either detects or estimates a temperature of the internal combustion engine or an ambient temperature of the ambient air in proximity to the internal combustion engine. In this embodiment, the engine stop control stops the operation of the internal combustion engine in the state of the lowered valve-side fuel pressure, which decreases to a lower level with an increase in temperature detected or estimated by the temperature detection-estimation unit. This arrangement more effectively reduces the frequency of operation of a relief valve or equivalent mechanism that works to prevent an excessive increase in valve-side fuel pressure, thus enhancing the durability of the relief valve or equivalent mechanism.

The first control method of the internal combustion engine of the invention is directed to the control method of the in-cylinder injection internal combustion engine. Upon satisfaction of a preset engine stop condition during operation of the internal combustion engine, the first control method executing an engine stop control that starts injection of a fuel from a fuel injection valve in the internal combustion engine and fires the injected fuel to lower a valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine, the engine stop control stopping the operation of the internal combustion engine in a state of the lowered valve-side fuel pressure.

The first control method of the internal combustion engine of the invention starts injection of the fuel from the fuel injection valve of the internal combustion engine and fires the injected fuel in the internal combustion engine to lower the valve-side fuel pressure on the fuel injection valve-side in the pressurized fuel supply unit than the fuel pressure level under the normal operation of the internal combustion engine. Here the pressurized fuel supply unit pressurizes the fuel flow and supplies the pressurized fuel flow to the fuel injection valve of the internal combustion engine. The control method stops the operation of the internal combustion engine in the state of the lowered valve-side fuel pressure. This arrangement effectively prevents the fuel oil-tight leaked from the fuel injection valve from being accumulated in a cylinder of the internal combustion engine during the stop of the internal combustion engine. This restrains the poor emission, which may be caused by direct discharge of the fuel accumulated in the cylinder at a restart of the internal combustion engine, and improves the emission. The control method of the invention does not stop the operation of the engine until a decrease of the valve-side fuel pressure. This arrangement desirably reduces the frequency of operation of a relief valve or equivalent mechanism that works to prevent an excessive increase in valve-side fuel pressure, thus enhancing the durability of the relief valve or equivalent mechanism.

Upon satisfaction of a preset engine restart condition, the first control method of the internal combustion engine may execute an engine restart control to restart the operation of the internal combustion engine, which has been stopped by the engine stop control. The internal combustion engine thus automatically starts under the preset engine restart condition.

The second control method of the internal combustion engine of the invention is directed to a control method of an internal combustion engine of the motor vehicle running with a changeover of a drive mode between an engine drive mode using the output power of the internal combustion engine and a motor drive mode using only the output power of the motor. Upon satisfaction of a preset engine stop condition during operation of the internal combustion engine, the second control method executing an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine; and upon satisfaction of a preset engine restart condition, the second control method executing an engine restart control to restart the operation of the internal combustion engine, which has been stopped by the engine stop control.

The second control method of the internal combustion engine of the invention starts injection of the fuel from the fuel injection valve of the internal combustion engine and fires the injected fuel in the internal combustion engine to lower the valve-side fuel pressure on the fuel injection valve-side in the pressurized fuel supply unit than the fuel pressure level under the normal operation of the internal combustion engine. Here the pressurized fuel supply unit pressurizes the fuel flow and supplies the pressurized fuel flow to the fuel injection valve of the internal combustion engine. The control method stops the operation of the internal combustion engine in the state of the lowered valve-side fuel pressure. This arrangement effectively prevents the fuel oil-tight leaked from the fuel injection valve from being accumulated in a cylinder of the internal combustion engine during the stop of the internal combustion engine. This restrains the poor emission, which may be caused by direct discharge of the fuel accumulated in the cylinder at a restart of the internal combustion engine, and improves the emission. The control method of the invention does not stop the operation of the engine until a decrease of the valve-side fuel pressure. This arrangement desirably reduces the frequency of operation of a relief valve or equivalent mechanism that works to prevent an excessive increase in valve-side fuel pressure, thus enhancing the durability of the relief valve or equivalent mechanism. Furthermore, internal combustion engine which is stopped restart the operation upon satisfaction of a preset engine restart condition and the internal combustion engine thus automatically starts under the preset engine restart condition.

### BRIEF DESCRIPTION OF THE DRAWINGS

FIG. 1 schematically illustrates the configuration of a hybrid vehicle in one embodiment of the invention;

FIG. 2 is a flowchart showing an engine stop control routine executed by an engine ECU mounted on the hybrid vehicle of the embodiment;

FIG. 3 shows one example of a correction factor setting map;

FIG. 4 schematically illustrates the configuration of another hybrid vehicle in one modified example;

FIG. 5 schematically illustrates the configuration of still another hybrid vehicle in another modified example; and

FIG. 6 schematically illustrates the configuration of another hybrid vehicle in still another modified example.

### DETAILED DESCRIPTION

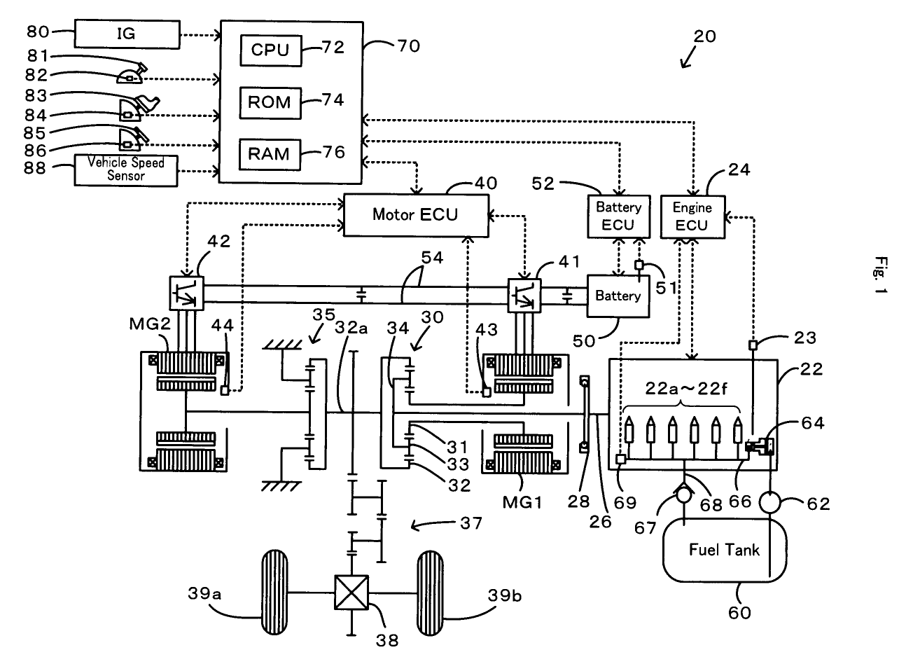

One mode of carrying out the invention is described below as a preferred embodiment with reference to the accompanied drawings. FIG. 1 schematically illustrates the construction of a hybrid vehicle 20 with a power output apparatus mounted thereon in one embodiment of the invention. As illustrated, the hybrid vehicle 20 of the embodiment includes an engine 22, a three shaft-type power distribution integration mechanism 30 that is linked with a crankshaft 26 functioning as an output shaft of the engine 22 via a damper 28, a motor MG1 that is linked with the power distribution integration mechanism 30 and is capable of generating electric power, a reduction gear 35 that is attached to a ring gear shaft 32a functioning as a drive shaft connected with the power distribution integration mechanism 30, another motor MG2 that is linked with the reduction gear 35, and a hybrid electronic control unit 70 that controls the whole power output apparatus.

The engine 22 is a direct-injection internal combustion engine with fuel injection valves 22a to 22f provided in respective cylinders for direct injection of a fuel. A supply of fuel fed from a fuel tank 60 by means of a fuel pump 62 is pressurized by a high-pressure fuel pump 64, which is actuated with the power of the crankshaft 26, and is led through a delivery pipe 66 to the respective fuel injection valves 22a to 22f for in-cylinder injection. The high-pressure fuel pump 64 is actuated by concavo-convex-based vertical motions of a camshaft, which is rotated by the rotation of the crankshaft 26. A check valve (not shown) is provided on the discharge side of the high-pressure fuel pump 64 to prevent the reverse flow of fuel and to keep the fuel pressure in the delivery pipe 66. The delivery pipe 66 is connected to a relief pipe 68, which returns the flow of fuel into the fuel tank 60 via a relief valve 67 that prevents an excessive rise of the fuel pressure. The engine 22 is under operation control of an engine electronic control unit 24 (hereafter referred to as engine ECU 24), which involves fuel injection control, fuel supply control, ignition control, and intake air flow regulation. The engine ECU 24 receives a fuel pressure Pf or pressure of the fuel in the delivery pipe 66 from a fuel pressure sensor 69 located in the delivery pipe 66 and an ambient temperature Tdp or temperature of the ambient air in the vicinity of the delivery pipe 66 from a temperature sensor 23 disposed close to the delivery pipe 66, as well as the various operating conditions of the engine 22. The engine ECU 24 establishes communication with the hybrid electronic control unit 70 to drive and control the engine 22 in response to control signals received from the hybrid electronic control unit 70 and to output data regarding the operating conditions of the engine 22 to the hybrid electronic control unit 70 according to the requirements.

The power distribution and integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution and integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution and integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 39a and 39b via the gear mechanism 37, and the differential gear 38 from ring gear shaft 32a.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements.

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 calculates a state of charge (SOC) of the battery 50, based on the accumulated charge-discharge current measured by the current sensor, for control of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a. The torque conversion drive mode is equivalent to the charge-discharge drive mode with the charge-discharge electric power of the battery 50 equal to zero. The hybrid vehicle 20 of the embodiment thus basically runs with changeover of the drive mode between the motor drive mode and the charge-discharge drive mode. The changeover of the drive mode between the charge-discharge drive mode and the motor drive mode is based on the power demand equivalent to the torque demand specified by the driver, the state of charge SOC of the battery 50, and the driver's selection of the drive mode. The engine 22 stops its operation with a change of the drive mode from the charge-discharge drive mode to the motor drive mode. The engine 22 restarts its operation, on the contrary, with a change of the drive mode from the motor drive mode to the charge-discharge drive mode.

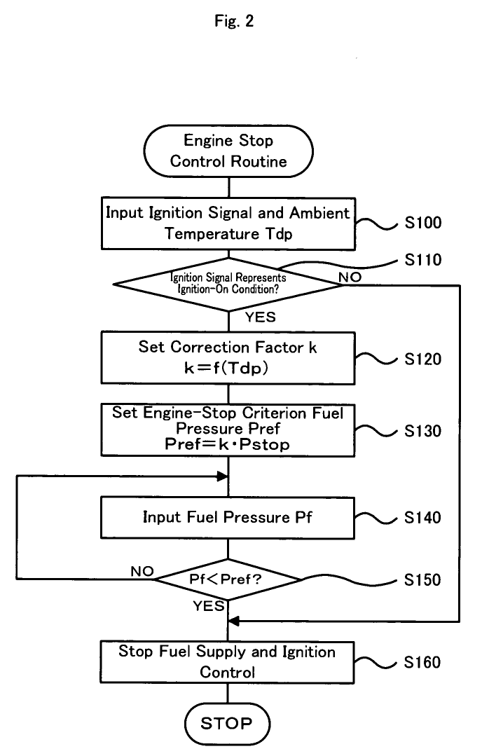

The description regards the operations of the hybrid vehicle 20 of the embodiment having the configuration discussed above, especially a series of control to stop the operation of the engine 22 in response to a change of the drive mode of the hybrid vehicle 20 from the charge-discharge drive mode to the motor drive mode. FIG. 2 is a flowchart showing an engine stop control routine executed by the engine ECU 24. This engine stop control routine is triggered by output of an engine stop request from the hybrid electronic control unit 70. The engine stop request is output from the hybrid electronic control unit 70 to the engine ECU 24 upon satisfaction of any one of predetermined engine stop conditions, for example, when the power demand decreases below a preset engine stop reference power specified as a criterion for engine stop under the condition of the sufficient state of charge SOC of the battery 50, when the driver operates a motor drive switch (not shown), or when the driver turns off an ignition switch 80.

In the engine stop control routine of FIG. 2, the engine ECU 24 first inputs an ignition signal and the ambient temperature Tdp in the vicinity of the delivery pipe 66 (step S100). In this embodiment, the ignition signal is received from the hybrid electronic control unit 70 by communication. The engine ECU 24 then identifies whether the input ignition signal represents an ignition-on condition or an ignition-off condition (step S110). Upon identification of the ignition-off condition (step S110: No) that represents the driver's system stop instruction, the engine ECU 24 immediately stops the fuel supply and the ignition to stop the operation of the engine 22 (step S160) and exits from this engine stop control routine.

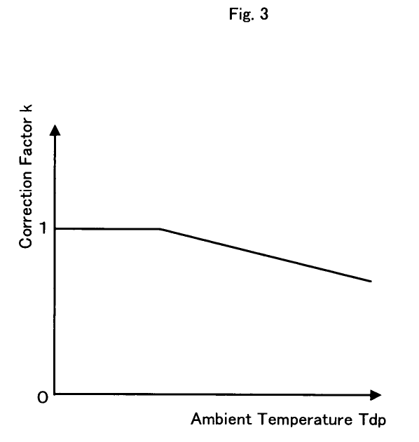

Upon identification of the ignition-on condition (step S110: Yes), on the other hand, there is a change of the drive mode from the charge-discharge drive mode to the motor drive mode. The ECU 24 accordingly sets a correction factor k according to the input ambient temperature Tdp (step S120) and multiplies a reference engine-stop fuel pressure Pstop by the correction factor k to set an engine-stop criterion fuel pressure Pref (step S130). The reference engine-stop fuel pressure Pstop should be not lower than a required fuel pressure of the delivery pipe 66 for ensuring the sufficient startability of the engine 22 but should be not higher than a fuel pressure for preventing the vapor generation. The reference engine-stop fuel pressure Pstop depends on the performances of the engine 22. The fuel pressure in the delivery pipe 66 varies with a variation in ambient temperature Tdp in the vicinity of the delivery pipe 66. The correction factor k is used to correct the reference engine-stop fuel pressure Pstop by taking into account this variation in fuel pressure in the delivery pipe 66. The correction factor k is set to decrease with an increase in ambient temperature Tdp. A concrete procedure of setting the correction factor k in this embodiment stores in advance a variation in correction factor k against the ambient temperature Tdp as a correction factor setting map in the ROM 74 and reads the correction factor k corresponding to the given ambient temperature Tdp from the correction factor setting map. One example of the correction factor setting map is shown in FIG. 3.

After setting the engine-stop criterion fuel pressure Pref, the engine ECU 24 inputs the fuel pressure Pf in the delivery pipe 66 from the fuel pressure sensor 69 (step S140) and compares the input fuel pressure Pf with the engine-stop criterion fuel pressure Pref (step S150). The engine ECU 24 waits until a decrease of the input fuel pressure Pf below the engine-stop criterion fuel pressure Pref (step S150: Yes) and stops the fuel supply and the ignition to stop the operation of the engine 22 (step S160). The engine stop control routine of FIG. 2 is then terminated. The fuel pressure Pf in the delivery pipe 66 is lowered by starting fuel injection from the fuel injection valves 22a to 22f and firing the injected fuel in the engine 22. When the fuel pressure Pf decreases below the engine-stop criterion fuel pressure Pref, the engine ECU 24 stops the fuel injection from the fuel injection valves 22a to 22f and the ignition control to stop the operation of the engine 22.

As described above, the hybrid vehicle 20 of the embodiment stops the operation of the engine 22 in the state of the lowered fuel pressure Pf in the delivery pipe 66 below the engine-stop criterion fuel pressure Pref. Such engine stop control effectively prevents the fuel oil-tight leaked from the fuel injection valves 22a to 22f from being accumulated in the cylinders. This restrains the poor emission, which may be caused by direct discharge of the fuel accumulated in the cylinders at a restart of the engine 22, and thus improves the emission. The hybrid vehicle 20 of the embodiment stops the operation of the engine 22 only after a decrease of the fuel pressure Pf in the delivery pipe 66 below the engine-stop criterion fuel pressure Pref. This reduces the frequency of operation of the relief valve 67, which works to prevent an excessive increase of the fuel pressure Pf, and thus enhances the durability of the relief valve 67. The engine-stop criterion fuel pressure Pref is set by multiplying the reference engine-stop fuel pressure Pstop by the correction factor k. Here the reference engine-stop fuel pressure Pstop is specified to the value ensuring the sufficient startability of the engine 22 and preventing the vapor generation. The correction factor k is based on the ambient temperature Tdp in the vicinity of the delivery pipe 66. The hybrid vehicle 20 does not stop the operation of the engine 22 until a decrease of the fuel pressure Pf below the engine-stop criterion fuel pressure Pref. This arrangement desirably ensures the sufficient startability of the engine 22 and effectively prevents the vapor generation and reduces the frequency of operation of the relief valve 67, even when the fuel pressure Pf in the delivery pipe 66 varies with a variation in ambient temperature Tdp in the vicinity of the delivery pipe 66 after a stop of the engine 22.

The hybrid vehicle 20 of the embodiment sets the correction factor k based on the ambient temperature Tdp in the vicinity of the delivery pipe 66. The influencing temperature is, however, not restricted to the ambient temperature Tdp in the vicinity of the delivery pipe 66. Setting the correction factor k may be based on any other temperature affecting the fuel pressure Pf in the delivery pipe 66, for example, based on the temperature inside the engine 22 or the temperature in the vicinity of the engine 22.

In the hybrid vehicle 20 of the embodiment, the engine stop control multiplies the reference engine-stop fuel pressure Pstop by the correction factor k, which depends on the ambient temperature Tdp in the vicinity of the delivery pipe 66, to set the engine-stop criterion fuel pressure Pref. The engine stop control stops the operation of the engine 22 when the fuel pressure Pf decreases below the engine-stop criterion fuel pressure Pref. One modified flow of the engine stop control may use the reference engine-stop fuel pressure Pstop as the engine-stop criterion fuel pressure Pref regardless of the ambient temperature Tdp in the vicinity of the delivery pipe 66 and may stop the operation of the engine 22 in response to a decrease in fuel pressure Pf below the engine-stop criterion fuel pressure Pref. In this modification, the reference engine-stop fuel pressure Pstop used as the engine-stop criterion fuel pressure Pref is preferably set to a value kept in the desired fuel pressure range of ensuring the startability of the engine 22 and preventing the vapor generation even when the fuel pressure Pf in the delivery pipe 66 varies with a variation in ambient temperature Tdp in the vicinity of the delivery pipe 66.

The hybrid vehicle 20 of the embodiment continuously operates the fuel injection valves 22a to 22f for continuing fuel injection to lower the fuel pressure Pf in the delivery pipe 66. Such continuous operation of the fuel injection valves 22a to 22f is, however, not essential, and any other suitable technique may be applied to lower the fuel pressure Pf in the delivery pipe 66. One applicable technique provides a decompression regulator in the delivery pipe 66 and operates the decompression regulator at a stop of the engine 22 to lower the fuel pressure Pf in the delivery pipe 66 below the engine-stop criterion fuel pressure Pref.

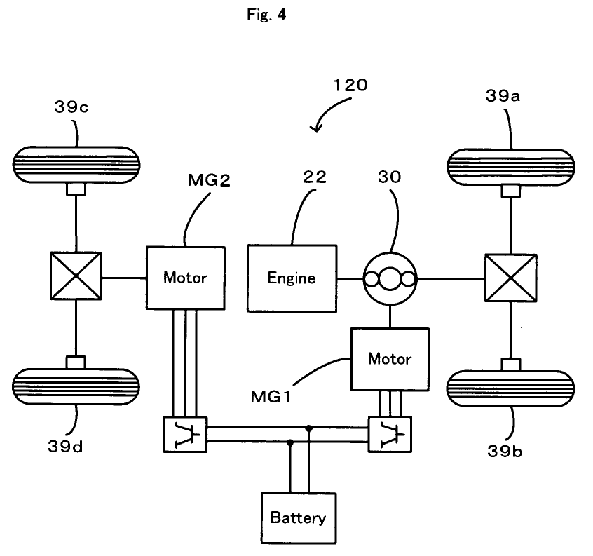

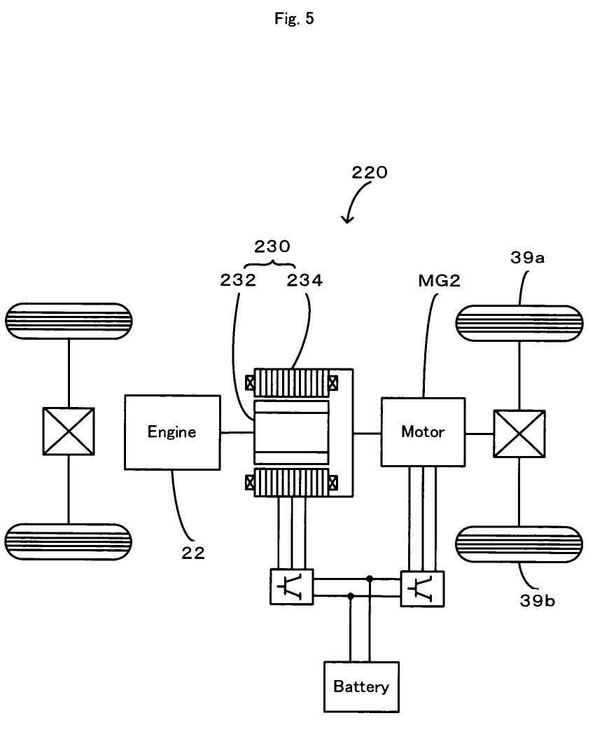

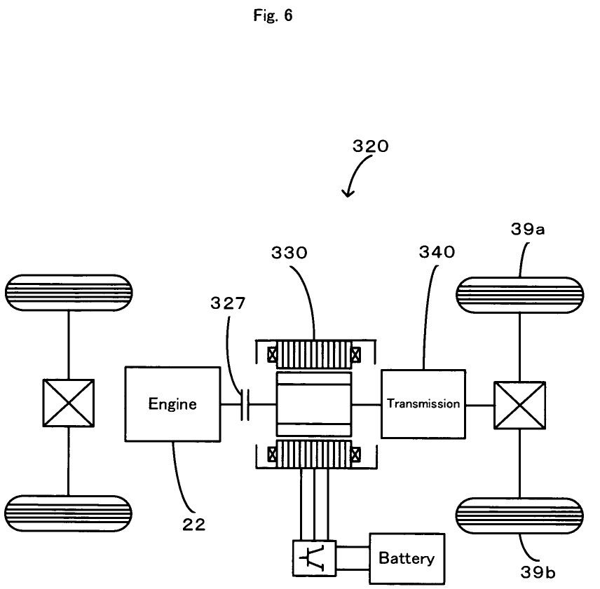

In the hybrid vehicle 20 of the embodiment, the crankshaft 26 of the in-cylinder injection engine 22 is connected to the power distribution integration mechanism 30, which is linked with the motors MG1 and MG2. The technique of the invention is, however, not restricted to the hybrid vehicle of this configuration but may be applied to other hybrid vehicles and motor vehicles of various configurations, which are equipped with an in-cylinder injection engine and are under auto engine stop restart control. The auto engine stop restart control automatically stops the engine upon satisfaction of any one of preset engine stop conditions and automatically restarts the engine upon satisfaction of any one of preset engine restart conditions. In such hybrid vehicles and motor vehicles, the engine stop control of the invention is applied to automatically stop the engine after a decrease of the fuel pressure in the delivery pipe. The technique of the invention may be applied to another hybrid vehicle 120 of one modified example shown in FIG. 4. In the hybrid vehicle 120 of FIG. 4, the power of the motor MG2 is connected to a different axle (an axle linked with wheels 39c and 39d) from the axle linked with the ring gear shaft 32a (that is, the axle linked with the drive wheels 39a and 39b). The technique of the invention may also be applied to still another hybrid vehicle 220 of another modified example shown in FIG. 5. The hybrid vehicle 220 of FIG. 5 has a pair-rotor motor 230, which includes an inner rotor 232 connected to the crankshaft 26 of the engine 22 and an outer rotor 234 connected to the driveshaft for outputting power to the drive wheels 39a and 39b. The pair-rotor motor 230 transmits part of the output power of the engine 22 to the driveshaft, while converting the residual output power into electric power. The technique of the invention may further be applied to another hybrid vehicle 320 of still another modified example shown in FIG. 6. In the hybrid vehicle 320 of FIG. 6, the engine 22 is connected by a clutch 327 to a rotating shaft of a motor 330, which outputs the power to the drive wheels 39a and 39b via a transmission 340. As described above, the technique of the invention is applicable to the hybrid vehicles of various configurations that have both the in-cylinder injection engine and the motor to output the power to the axle and are allowed to run with a changeover of the drive mode between the engine drive mode using the power of the engine and the motor drive mode using only the power of the motor. The technique of the invention is, however, not restricted to such hybrid vehicles but is also applicable to conventional motor vehicles that do not have a motor as a driving power source and run with only the power of an engine. One typical example of the auto stop restart control in the conventional motor vehicles is idling stop control. At the time of an auto stop of the engine in idling stop control, the engine stop control of the invention may be applied to lower the fuel pressure in a delivery pipe before stopping the operation of the engine.

In the hybrid vehicle 20 of the embodiment, at the time of an auto stop of the engine 22 in response to an engine stop request other than the driver's ignition-off operation, the engine stop control lowers the fuel pressure Pf in the delivery pipe 66 below the engine-stop criterion fuel pressure Pref before stopping the operation of the engine 22. In one possible modification, the engine stop control may lower the fuel pressure Pf in the delivery pipe 66 below the engine-stop criterion fuel pressure Pref before stopping the operation of the engine 22 at the time of an auto stop of the engine 22 in response to any engine stop request including the driver's ignition-off operation.

The embodiment regards application of the engine stop control of the invention to stop the operation of the in-cylinder injection engine mounted on the hybrid vehicle. The engine stop control technique of the invention is also applicable to stop the operation of an internal combustion engine mounted on any other vehicles as well as hybrid vehicles and motor vehicles and diversity of other moving bodies including ships and boats and aircraft. The engine stop control technique of the invention may further be applied to stop the operation of an internal combustion engine built in diversity of stationary machines, for example, power generation equipment.

The embodiment and its modifications discussed above are to be considered in all aspects as illustrative and not restrictive. There may be many other modifications, changes, and alterations without departing from the scope or spirit of the main characteristics of the present invention. All changes within the meaning and range of equivalency of the claims are intended to be embraced therein. The scope and spirit of the present invention are indicated by the appended claims, rather than by the foregoing description.

### INDUSTRIAL APPLICABILITY

The technique of the invention is preferably applied to the manufacturing industries of internal combustion engines and automobiles.

What is claimed is:

1. A control apparatus for an in-cylinder injection internal combustion engine,
upon satisfaction of a preset engine stop condition during operation of the internal combustion engine, said control apparatus executing an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine.

2. A control apparatus in accordance with claim 1, upon satisfaction of a preset engine restart condition, said control apparatus executing an engine restart control to restart the operation of the internal combustion engine, which has been stopped by the engine stop control.

3. A control apparatus in accordance with claim 1, wherein the engine stop control starts injection of a fuel from the fuel injection valve and fires the injected fuel in the internal combustion engine to lower the valve-side fuel pressure.

4. A control apparatus in accordance with claim 1, wherein the engine stop control stops the operation of the internal combustion engine only after lowering the valve-side fuel pressure.

5. A control apparatus in accordance with claim 1, wherein the engine stop control stops the operation of the internal combustion engine only after lowering the valve-side fuel pressure to or below a preset reference fuel pressure, which is set to ensure startability for a restart of the internal combustion engine under the engine restart control.

6. A control apparatus in accordance with claim 1, said control apparatus comprising a temperature detection-estimation unit that either detects or estimates a temperature of the internal combustion engine or an ambient temperature of the ambient air in proximity to the internal combustion engine,
wherein the engine stop control stops the operation of the internal combustion engine in the state of the lowered valve-side fuel pressure, which decreases to a lower level with an increase in temperature detected or estimated by the temperature detection-estimation unit.

7. A motor vehicle, comprising:
an in-cylinder injection internal combustion engine that outputs a power for driving said motor vehicle; and
an engine control apparatus that, upon satisfaction of a preset engine stop condition during operation of the internal combustion engine, executes an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine.

8. A motor vehicle in accordance with claim 7, said motor vehicle further comprising a motor that outputs a power for driving said motor vehicle.

9. A motor vehicle in accordance with claim 8, said motor vehicle running with a changeover of a drive mode between an engine drive mode using the output power of the internal combustion engine and a motor drive mode using only the output power of the motor.

10. A motor vehicle in accordance with claim 9, wherein upon satisfaction of a preset engine restart condition, the engine control apparatus executing an engine restart control to restart the operation of the internal combustion engine, which has been stopped by the engine stop control.

11. A motor vehicle in accordance with claim 9, wherein the engine stop control starts injection of a fuel from the fuel injection valve and fires the injected fuel in the internal combustion engine to lower the valve-side fuel pressure.

12. A motor vehicle in accordance with claim 9, wherein the engine stop control stops the operation of the internal combustion engine only after lowering the valve-side fuel pressure.

13. A motor vehicle in accordance with claim 9, wherein the engine stop control stops the operation of the internal combustion engine only after lowering the valve-side fuel pressure to or below a preset reference fuel pressure, which is set to ensure startability for a restart of the internal combustion engine under the engine restart control.

14. A motor vehicle in accordance with claim 9, said motor vehicle comprising a temperature detection-estimation unit that either detects or estimates a temperature of the internal combustion engine or an ambient temperature of the ambient air in proximity to the internal combustion engine,
wherein the engine stop control stops the operation of the internal combustion engine in the state of the lowered valve-side fuel pressure, which decreases to a lower level with an increase in temperature detected or estimated by the temperature detection-estimation unit.

15. A control method of an in-cylinder injection internal combustion engine,
upon satisfaction of a preset engine stop condition during operation of the internal combustion engine, said control method executing an engine stop control that starts injection of a fuel from a fuel injection valve in the internal combustion engine and fires the injected fuel to lower a valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine,
the engine stop control stopping the operation of the internal combustion engine in a state of the lowered valve-side fuel pressure.

16. A control method of the internal combustion engine in accordance with claim 15, upon satisfaction of a preset engine restart condition, said control method executing an engine restart control to restart the operation of the internal combustion engine, which has been stopped by the engine stop control.

17. A control method of an internal combustion engine of the motor vehicle running with a changeover of a drive mode between an engine drive mode using the output power of the internal combustion engine and a motor drive mode using only the output power of the motor,
upon satisfaction of a preset engine stop condition during operation of the internal combustion engine, said control method executes an engine stop control to stop the operation of the internal combustion engine in a state of a lowered valve-side fuel pressure on a fuel injection valve-side in a pressurized fuel supply unit than a fuel pressure level under a normal operation of the internal combustion engine, where the pressurized fuel supply unit pressurizes a fuel flow and supplies the pressurized fuel flow to a fuel injection valve of the internal combustion engine; and
upon satisfaction of a preset engine restart condition, said control method executing an engine restart control to restart the operation of the internal combustion engine, which has been stopped by the engine stop control.
